(19) United States
(12) Patent Application Publication
(10) Pub. No.: US 2010/0182530 A1
(43) Pub. Date: Jul. 22, 2010

(54) DISPLAY CELL

(75) Inventor: Yohsuke Fujikawa, Osaka (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka-shi, Osaka (JP)

(21) Appl. No.: 12/664,219

(22) PCT Filed: May 29, 2008
(86) PCT No.: PCT/JP2008/001351

§ 371 Date: Dec. 11, 2009

(30) Foreign Application Priority Data
Sep. 28, 2007 (JP) 2007-255625

(51) Int. Cl. G02F 1/1333

(52) U.S. Cl. 349/58

(57) ABSTRACT

A display cell (50a) includes: a first substrate (20a); a terminal region (T) defined along one side of the first substrate (20a); a second substrate (30a) opposed to the first substrate (20a) so that the terminal region (T) is exposed; a frame-shaped sealing material (25a) configured to attach the first substrate (20a) and the second substrate (30a) to each other and have a widened seal joint (S); a display region (D) defined inside the frame of the sealing material (25a); and a frame region having four side portions defined around the display region (D), the sealing material (25a) being placed in the frame region. The sealing material (25a) is placed to be farther from the edge of the second substrate (30a) in the widest side portion of the frame region, among the four side portions, than in the other three side portions, and has the seal joint (S) in the widest side portion.

### TECHNICAL FIELD

The present disclosure relates to a display cell manufactured by bonding a pair of substrates together with a sealing material, and more particularly to a liquid crystal cell manufactured by a one drop fill method.

### BACKGROUND ART

A general liquid crystal cell has a structure of a first substrate and a second substrate different in size bonded together with a frame-shaped sealing material. Electrodes for applying a voltage across a liquid crystal layer sandwiched between the substrates are placed on the surfaces of the first and second substrates to face each other.

FIG. 8 is a plan view of a conventional liquid crystal cell 150a having monolithic circuits formed in a substrate. FIG. 9 is a plan view illustrating a configuration of a sealing material 125a in the liquid crystal cell 150a.

As shown in FIGS. 8 and 9, the liquid crystal cell 150a has a thin film transistor (TFT) substrate 120 and a color filter (CF) substrate 130 as the first substrate and the second substrate described above bonded together with the sealing material 125a. In the liquid crystal cell 150a, the following regions are defined as shown in FIGS. 8 and 9: a display region D contributing to display; a frame region having four side portions surrounding the display region D; and a terminal region T lying under the lower-side portion of the frame region as viewed from the figure. As shown in FIG. 8, the TFT substrate 120 includes, in the lower- and right-side portions of the frame region surrounding the display region D as viewed from the figure, a gate driver circuit 114, a source driver circuit 115, a peripheral circuit 116, and a plurality of interconnects 112 connected to a plurality of connecting terminals 113 in the terminal region T. The peripheral circuit 116 includes a power supply circuit placed for enhancing the integration density, a level shifter for changing the voltage level, and an optical sensor circuit, for example. In the liquid crystal cell 150a having this configuration, the widths of the four side portions of the frame region surrounding the display region D are not necessarily the same but depend on the configuration of the circuits and the interconnects placed in these portions. Note that the gate driver circuit 114, the source driver circuit 115, the peripheral circuit 116, the connecting terminals 113, and the interconnects 112 are formed simultaneously with the components (not shown) such as TFTs and pixel electrodes formed in the display region D of the TFT substrate 120.

The “three-side-free structure” as shown in FIG. 8 in which terminals are placed only on one side is adopted favorably in liquid crystal cells for cellular phones because this structure can reduce the number of circuit components and is advantageous in connection reliability and cost performance.

The sealing material 125a shown in FIGS. 8 and 9 extends along the four sides (Ea, Eb, Ec, and Ed) of the liquid crystal cell 150a so that the center of the line width thereof is invariably at the same distance from the edge of the liquid crystal cell 150a. To state specifically, in the liquid crystal cell 150a shown in FIG. 9, Lax=Lbx=Lcx=Ldx is satisfied. When the finished line width of the sealing material 125a is 1.0 mm, for example, Lax=Lbx=Lcx=Ldx=0.9 mm will be satisfied. The sealing material 125a is concealed under a black matrix formed in the frame region to be invisible from outside.

In manufacture of liquid crystal cells, the “one drop fill” method, in which filling and sealing of a liquid crystal material is performed simultaneously, is advantageous in reducing the manufacturing cost. The one drop fill method was first introduced in large-sized liquid crystal cells having a comparatively wide frame region for use in PC monitors and TV sets. Recently, this method has also been introduced in small-sized liquid crystal cells for cellular phones and the like and expected to become the mainstream in the future. It is therefore necessary to accumulate know-how on design and manufacture based on this method.

In a general one drop fill method, a closed pattern of a sealing material having a predetermined line width is formed (drawn) along the periphery of the overlap region of the first and second substrates using a dispenser. The dispenser is configured to discharge the sealing material from its discharge head having a predetermined aperture onto a substrate, to draw the pattern of the sealing material on the substrate. The dispenser has a sensor near the discharge head to sense the vicinity of a position on a line to be drawn on the substrate, thereby to keep the height of the discharge head from the substrate constant.

Since the closed pattern of the sealing material 125a (see FIGS. 8 and 9) is drawn as described above, a seal joint S wider than the portion drawn straight is inevitably formed at the joint of the start point and end point of the drawing.

The seal joint S may be formed at an arbitrary position on one of the four sides of the liquid crystal cell 150a, but is often formed on the side Ea that faces the side Ec, on which the connecting terminals 113 are placed, across the display region D, as shown in FIGS. 8 and 9. The reason for this is not certain, but is considered following the sealing design of a liquid crystal cell 150b manufactured by a “vacuum injection” method shown in FIG. 10.

In the vacuum injection method, an end portion of a hollow liquid crystal cell is immersed in a liquid crystal pan filled with a liquid crystal material. In the liquid crystal cell 150b, therefore, an opening H for a sealing material 125b is formed on the side Ea that is away from the terminal region T, as shown in FIG. 10, for convenience in this manufacturing process. Also, as in the liquid crystal cell 150a manufactured by the one drop fill method, the sealing material 125b is formed along the four sides (Ea, Eb, Ec, and Ed) of the liquid crystal cell 150b so that the center of the line width thereof is invariably at the same distance from the edge of the liquid crystal cell 150b. To state specifically, in the liquid crystal cell 150b shown in FIG. 10, Lay=Lby=Lcy=Ldy is satisfied. Hence, the seal design in the one drop fill method shown in FIG. 8 is considered following the seal design in the vacuum injection method shown in FIG. 10, replacing the opening H with the seal joint S.

For example, Patent Document 1 discloses a liquid crystal cell manufactured by the one drop fill method, in which the seal joint is formed on the side having terminals or the side opposite to the side having terminals.

Patent Document 2 discloses a liquid crystal cell manufactured by the vacuum injection method, in which the sealing material is apart from the cutting position on three sides out of the four sides compared with on the one remaining side, and also discloses a liquid crystal cell manufactured by the one drop fill method, in which the sealing material is apart from the cutting position on two sides out of the four sides compared with on the two remaining sides.

### CITATION LIST

### Patent Document

PATENT DOCUMENT 1: Japanese Patent Publication No. P2007-65037

PATENT DOCUMENT 2: Japanese Patent Publication No. P2001-281674

### SUMMARY OF THE INVENTION

### Technical Problem

In a large-sized liquid crystal cell having a frame region whose width is about 5 mm, for example, a sufficient allowance is secured for design of a sealing material having a finished line width of about 1 mm. Therefore, there was found no possibility that the seal joint described above might cause a problem during manufacture. In this situation, naturally, the one drop fill method was introduced in large-sized liquid crystal cells. In other words, in the one drop fill method, it was possible to follow the seal design in the vacuum injection method.

In recent years, in liquid crystal cells for cellular phones, the width of the frame region required has become as small as less than 2 mm. It is therefore necessary to draw a pattern of a sealing material to be narrow in line width and as close to the outer periphery of the liquid crystal cell as possible. However, since the sealing material spreads widthwise at the bonding of the substrates, it is difficult to have a narrow finished line width.

When the frame region is narrow, the seal joint formed on whichever side of the four sides of the liquid crystal cell will inevitably be near a cutting edge of the liquid crystal cell. In particular, when the seal joint is formed over a cutting line of the liquid crystal cell, a work-related problem will occur in the cutting process of cutting out the liquid crystal cell from mother glass.

To state more specifically, when the first and second substrates constituting the liquid crystal cell is as thick as about 0.5 mm, for example, it may be possible to cut the liquid crystal cell from the mother glass in the manner of pulling apart the portion of the sealing material spreading over the cutting position together with the glass substrate almost forcibly. However, when the first and second substrates are as thin as about 0.2 mm, for example, at the time of pulling the spreading portion of the sealing material, the glass substrate may not be cut at a predetermined position, or the first and second substrates themselves may break by mistake. FIG. 11 is a cross-sectional view of a liquid crystal cell having cutting failure. As shown in FIG. 11, the portion of a sealing material 125 on the side close to the terminal region T spreads beyond a cutting line P. This makes it difficult to separate a wastable substrate portion W of the CF substrate 130 facing the terminal region T from the CF substrate 130 normally. As illustrated, when the CF substrate 130 is thin, the strength of the substrate itself is small. Therefore, when being pulled apart forcibly, the wastable substrate portion W is not separated from the CF substrate 130 at the normal position (cutting line P). Moreover, the CF substrate 130 is often broken together with the wastable substrate portion W.

In view of the problem described above, an object of the present invention is suppressing cutting failure caused by the seal joint.

### Solution to the Problem

To attain the above object, according to the present invention, a sealing material having a seal joint is placed to be farther from the substrate edge in the widest side portion of a frame region, among four side portions thereof, than in the other three side portions, and the seal joint is formed in the widest side portion of the frame region.

Specifically, the display cell of the present invention includes: a first substrate; a terminal region defined along one side of the first substrate; a second substrate opposed to the first substrate so that the terminal region is exposed; a frame-shaped sealing material configured to attach the first substrate and the second substrate to each other and have a widened seal joint; a display region defined inside the frame of the sealing material; and a frame region having four side portions defined around the display region, the sealing material being placed in the frame region, wherein the sealing material is placed to be farther from the edge of the second substrate in a widest side portion of the frame region, among the four side portions thereof, than in the other three side portions, and has the seal joint in the widest side portion.

According to the configuration described above, the portion of the sealing material in the widest side portion of the frame region, among the four side portions thereof, has the widened seal joint and is placed to be farther from the edge of the second substrate than the portions of the sealing material in the other three side portions of the frame region. This allows the seal joint to be apart from the edge of the second substrate. Hence, with the seal joint being apart from the edge of the second substrate, i.e., the cutting line along which the second substrate is to be cut from the mother substrate, good cutting is secured on the side of the second substrate having the seal joint, and hence cutting failure caused by the seal joint is suppressed.

A plurality of first column spacers for holding the spacing between the first substrate and the second substrate may be formed in the display region, a plurality of second column spacers for holding the spacing between the first substrate and the second substrate may be formed in the widest side portion of the frame region, where the second column spacers is lower in arrangement density than the first column spacers, or smaller than the first column spacers, and the spacing between the first substrate and the second substrate may be held with the sealing material in the other three side portions of the frame region.

According to the configuration described above, the spacing between the first substrate and the second substrate, i.e., the cell thickness is held with the first column spacers in the display region, the cell thickness is held with the second column spacers in the relatively wide side portion of the frame region, and the cell thickness is held with the sealing material in the other three relatively narrow side portions of the frame region. Since the second column spacers are lower in arrangement density or smaller than the first column spacers, drawing of the portion of the sealing material in the wide side portion of the frame region can be made with high precision without being impeded by the second column spacers. Also, with the existence of the second column spacers in the wide side portion of the frame region, the cell thickness is prevented from changing abruptly at and around the boundary between the display region and the wide side portion of the frame region, and hence the display quality can be maintained. Moreover, in the three narrow side portions of the frame region, which are less influential to display quality, the cell thickness is held, not with column spacers, but with only the sealing material. In this way, in the liquid crystal cell, the frame can be narrowed while the display quality is maintained.

A monolithic circuit may be formed in the widest side portion of the frame region of the first substrate.

According to the above configuration, since a monolithic circuit such as a driver circuit, for example, is comparatively large, the side portion of the frame region in which the monolithic circuit is formed is widened.

The seal joint may overlap the monolithic circuit or a lead interconnect running from the monolithic circuit.

According to the above configuration, although the seal joint overlaps the monolithic circuit or lead interconnects running from the monolithic circuit, good cutting is secured on the side of the second substrate having the seal joint, because the seal joint is apart from the edge of the second substrate, i.e., the cutting line along which the second substrate is to be cut from the mother substrate.

The second substrate may be thinner than the first substrate.

According to the above configuration, although the second substrate is relatively thin, good cutting is secured on the side of the second substrate having the seal joint, because the seal joint is apart from the edge of the second substrate, i.e., the cutting line along which the second substrate is to be cut from the mother substrate.

An integrated circuit chip may be mounted on the terminal region.

According to the above configuration, since an integrated circuit chip is mounted on the relatively thick first substrate, occurrence of cracking and chipping of the first substrate during mounting of the integrated circuit chip is suppressed.

A liquid crystal layer sealed with the sealing material may be formed between the first substrate and the second substrate.

According to the above configuration, the liquid crystal layer is sealed between the first substrate and the second substrate with the frame-shaped sealing material, thereby to present a liquid crystal cell manufactured by the one drop fill method. Since only the portion of the sealing material in the widest side portion of the frame region, among the four side portions thereof, is placed apart from the edge of the second substrate, the space enclosed with the first and second substrate and the sealing material in which the liquid crystal material is dropped is prevented from being excessively small. With the space in which the liquid crystal material is dropped being maintained, occurrence of an uneven cell thickness caused by variations in the drop amount of the liquid crystal material is suppressed.

The terminal region may be adjacent to the widest side portion of the frame region.

According to the above configuration, the terminal region and the wide side portion of the frame region are adjacent to each other. This improves the degree of freedom in the layout of interconnects running from the wide side portion of the frame region to the terminal region.

The sealing material may be placed by drawing, and the seal joint may be a portion where the start point and the end point of the drawing join with each other.

According to the above configuration, the portion where the start point and the end point of the drawing of the frame-shaped sealing material join with each other constitutes the widened seal joint.

### ADVANTAGES OF THE INVENTION

According to the present invention, the sealing material having the seal joint is placed to be farther from the substrate edge in the widest side portion of the frame region, among the four side portions thereof, than in the other three side portions, and the seal joint is formed in the widest side portion of the frame region. Having this configuration, cutting failure caused by the seal joint can be suppressed.

### BRIEF DESCRIPTION OF THE DRAWINGS

FIG. 1 is a plan view of a liquid crystal cell 50a of Embodiment 1.

FIG. 2 is a plan view illustrating a configuration of a sealing material 25a in the liquid crystal cell 50a.

FIG. 3 is a cross-sectional view of the liquid crystal cell 50a taken along line in FIG. 1.

FIG. 4 is a plan view of a liquid crystal cell 50b of Embodiment 2.

FIG. 5 is a plan view illustrating a configuration of the sealing material 25a in the liquid crystal cell 50b.

FIG. 6 is a cross-sectional view of the liquid crystal cell 50b taken along line VI-VI in FIG. 4.

FIG. 7 is a plan view of a liquid crystal cell 50c of Embodiment 3.

FIG. 8 is a plan view of a conventional liquid crystal cell 150a.

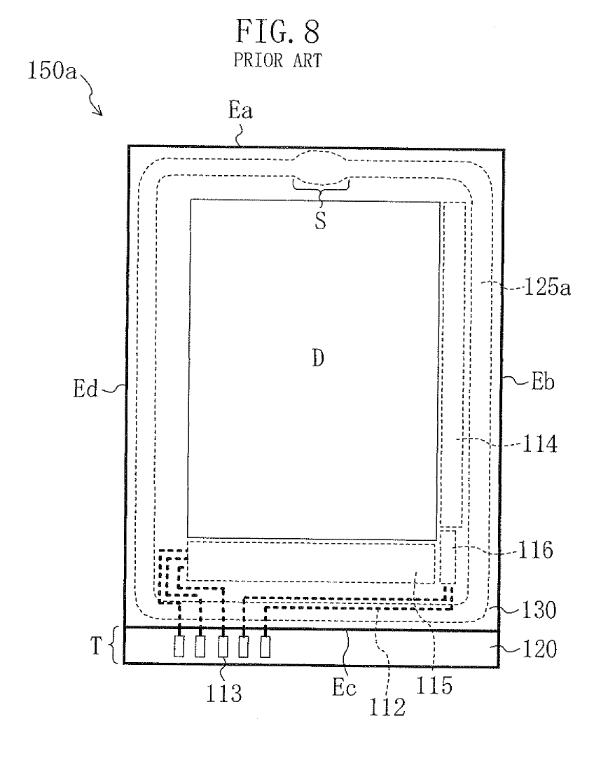

FIG. 9 is a plan view illustrating a configuration of a sealing material 125a in the liquid crystal cell 150a.

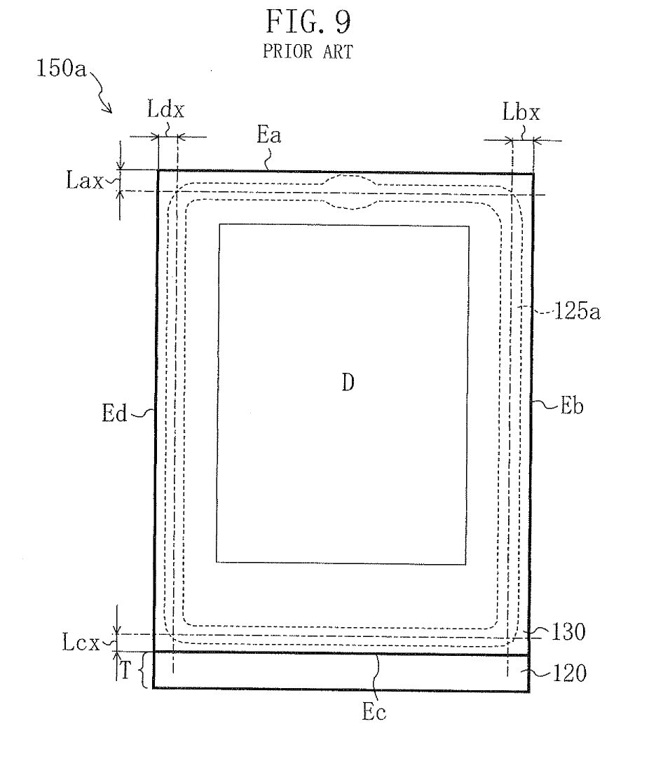

FIG. 10 is a plan view of a conventional liquid crystal cell 150b.

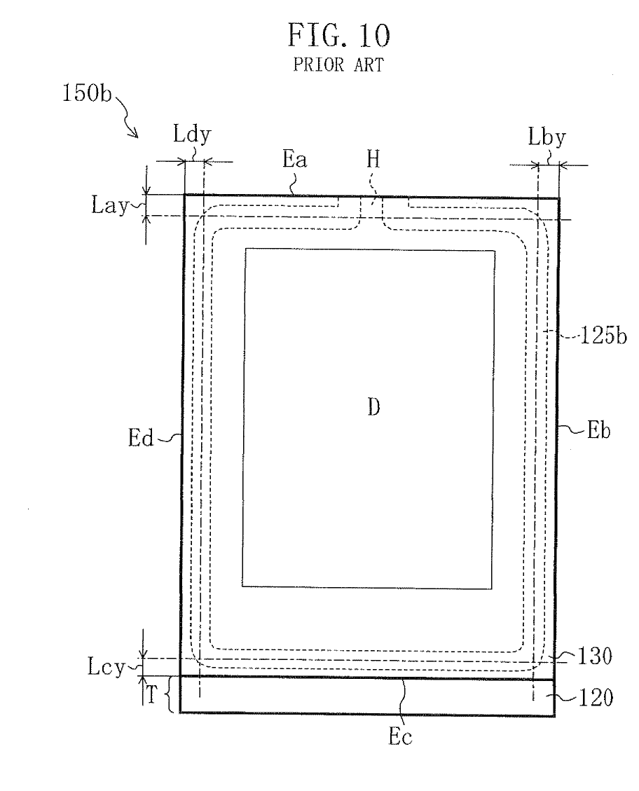

FIG. 11 is a cross-sectional view of a conventional liquid crystal cell having cutting failure.

### DESCRIPTION OF REFERENCE CHARACTERS

D Display region
F Frame region
S Seal joint
12, 19 Lead interconnect
14 Gate driver circuit (monolithic circuit)
15 Source driver circuit (monolithic circuit)
16 Peripheral circuit (monolithic circuit)
20a, 20b TFT substrate (first substrate)
21a, 21b First column spacer
22a, 22b Second column spacer
25a, 25b Sealing material
30a, 30b CF substrate (second substrate)
41 Integrated circuit chip
50a, 50b, 50c Liquid crystal cell (display cell)

### DESCRIPTION OF EMBODIMENTS

Embodiments of the present invention will be herein described in detail with reference to the relevant drawings. It should be noted that the present invention is not limited to the embodiments to follow.

### Embodiment 1

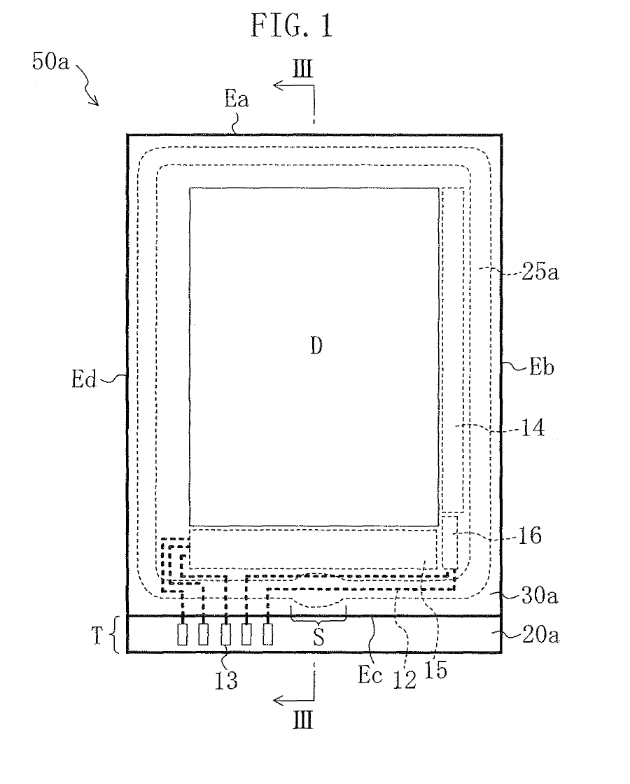

FIGS. 1 to 3 show a display cell (liquid crystal cell) of Embodiment I of the present invention.

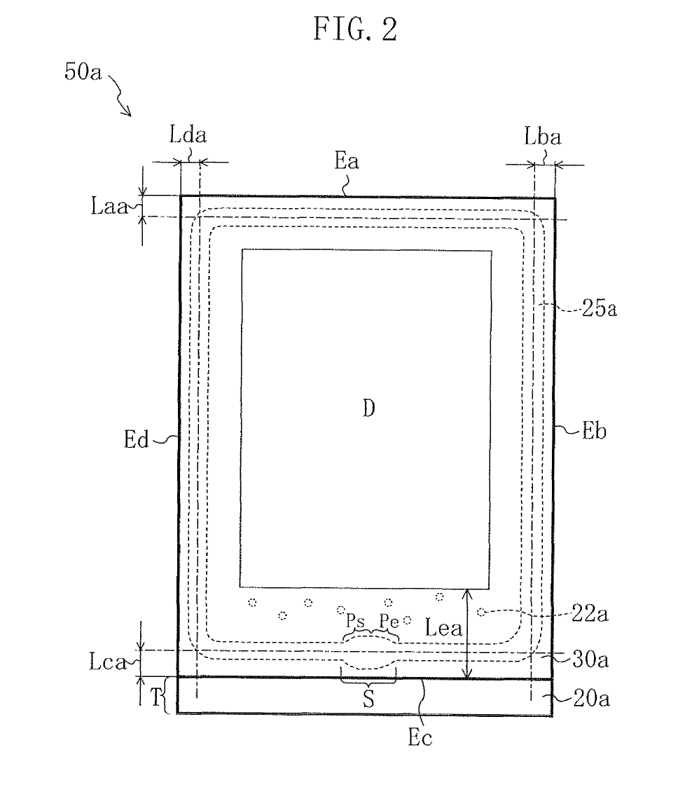

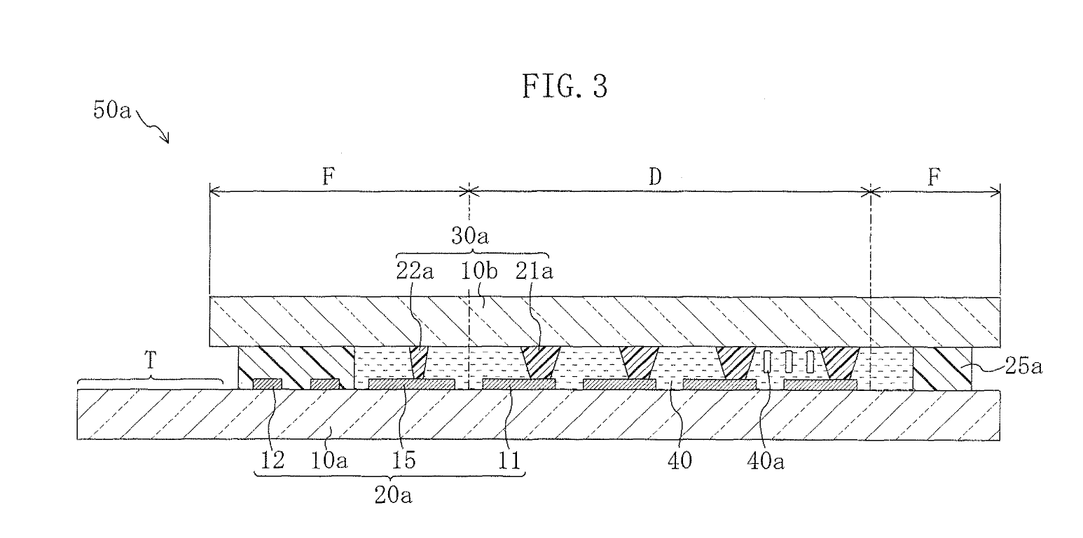

Specifically, FIG. 1 is a plan view of a liquid crystal cell 50a of this embodiment, FIG. 2 is a plan view illustrating a configuration of a sealing material 25a in the liquid crystal cell 50a, and FIG. 3 is a cross-sectional view of the liquid crystal cell 50a taken along line III-III in FIG. 1.

As shown in FIGS. 1 to 3, the liquid crystal cell 50a includes: a TFT substrate 20a as the first substrate; a CF substrate 30a as the second substrate opposed to the TFT substrate 20a; a liquid crystal layer 40 formed between the TFT substrate 20a and the CF substrate 30a; and the frame-shaped sealing material 25a for attaching the TFT substrate 20a and the CF substrate 30a to each other and sealing the liquid crystal layer 40 between the TFT substrate 20a and the CF substrate 30a.

As shown in FIGS. 1 to 3, also, the following regions are defined in the liquid crystal cell 50a: a display region D contributing to display located inside the frame of the sealing material 25a; a frame region having four side portions around the display region D, in which the sealing material 25a is placed; and a terminal region T as a portion of the TFT substrate 20a exposed outside the CF substrate 30a. The liquid crystal cell 50a has a “three-side free structure” in which the terminal region T exists only on one side.

As shown in FIG. 3, the TFT substrate 20a includes a plurality of pixel electrodes 11 arranged in a matrix on a glass substrate 10a in the display region D. The TFT substrate 20a also includes, between the glass substrate 10a and the plurality of pixel electrodes 11, a plurality of gate lines (not shown) running in parallel with one another, a plurality of source lines (not shown) running in parallel with one another perpendicularly to the gate lines, a plurality of TFTs (not shown) placed at the intersections of the gate lines and the source lines, and the like. Each of the pixel electrodes 11 constitutes a pixel as the minimum unit of an image.

In the TFT substrate 20a, also, as shown in FIG. 1, a gate driver circuit 14 and a peripheral circuit 16 as monolithic circuits are placed in the right-side portion of the frame region F, and a source driver circuit 15 as a monolithic circuit and a plurality of lead interconnects 12 are placed in the lower-side portion of the frame region F, as viewed from the figure. The peripheral circuit 16, which includes a power supply circuit, a level shifter for converting the voltage level, and an optical sensor circuit, for example, is placed in unused space of the frame region F to enhance the integration density.

Moreover, in the TFT substrate 20a, as shown in FIG. 1, a plurality of connecting terminals 13 connecting with the plurality of lead interconnects 12 in the lower-side portion of the frame region F are placed in the terminal region T.

The gate driver circuit 14, the source driver circuit 15, the peripheral circuit 16, the lead interconnects 12, and the connecting terminals 13 placed in the frame region F and the terminal region T are formed monolithically together with the TFTs and the pixel electrodes 11 in the display region D by a known method.

In the TFT substrate 20a configured as described above, the side portion of the frame region F along the side Ec, in which the source driver circuit 15 and the lead interconnects 12 are placed, is widest, and the side portion of the frame region F along the side Ea, in which no driver circuit is placed, is narrowest, among the four side portions of the frame region F surrounding the display region D. That is, (the width of the side Ec portion of the frame region F)>(the width of the side Ea portion of the frame region F) is satisfied. In liquid crystal cells for cellular phones, it is preferred for the right- and left-side portions of the frame region F to have the same width. Hence, (the width of the side Eb portion of the frame region F)=(the width of the side Ed portion of the frame region F) is adopted in overwhelmingly many cases. Since the gate driver circuit 14 is a comparatively simple circuit, and the spacing between the gate lines is wider than the spacing between the source lines, the gate driver circuit 14 can be laid out in a region narrower than the region for the source driver circuit 15 in many cases. Considering the above, the relationship of (the width of the side Ec portion of the frame region F)>(the width of the side Eb portion of the frame region F)=(the width of the side Ed portion of the frame region F)>(the width of the side Ea portion of the frame region F), or (the width of the side Ec portion of the frame region F)>(the width of the side Eb portion of the frame region F)=(the width of the side Ed portion of the frame region F)=(the width of the side Ea portion of the frame region F), can be satisfied.

In other words, in a liquid crystal cell that adopts the three-side free structure and has both a side having a monolithic circuit and a side having no monolithic circuit, at least one side portion of the frame region F will be wider than the other side portions of the frame region F. Typically, the side portion of the frame region F along the side on which the terminal region T is defined will be widest. The present invention pays attention to this point as will be described later.

The CF substrate 30a includes a plurality of first column spacers 21a and second column spacers 22a formed on a glass substrate 10b in the display region D and the side Ec portion of the frame region F, respectively, as shown in FIGS. 2 and 3. The CF substrate 30a also includes, between the glass substrate 10b and the first and second column spacers 21a and 22a, a lattice-shaped black matrix (not shown), a color filter layer (not shown) including red, green, and blue color layers placed in the openings of the lattice of the black matrix as coloring layers so as to correspond to the pixel electrodes 11 on the TFT substrate 20a, a common electrode (not shown) formed to cover the color filter layer, and the like.

The first column spacers 21a are post spacers of a roughly cylindrical shape having a height of several μm, for example, formed to hold the spacing between the TFT substrate 20a and the CF substrate 30a, i.e., the cell thickness in the display region D. The first column spacers 21a are placed at a density of one for each pixel or one for each coloring layer of a specific color, or at random, in the display region D. In general, when the CF substrate that is to be the display plane of the liquid crystal cell is thin, temporary disturbance of display is likely to occur when an external force is exerted on the display plane with a finger and the like. By placing post spacers, like the first column spacers 21a, in the display region D at a density equal to or higher than a predetermined density, recover from such display disturbance can be made in a short time.

The second column spacers 22a are post dummy spacers of a roughly cylindrical shape having a height of several μm, for example, formed to hold the spacing between the TFT substrate 20a and the CF substrate 30a, i.e., the cell thickness in the wide side Ec portion of the frame region F. The diameter of the second column spacers 22a is 9 μm, for example, which is smaller than the diameter (e.g., 12 μm) of the first column spacers 21a. Therefore, the second column spacers 22a are less likely to interfere with sensing of a dispenser in drawing of the frame-shaped sealing material 25a in a seal drawing process to be described later. In addition, with the existence of the second column spacers 22a, the cell thickness is prevented from changing abruptly at and around the boundary between the display region D and the widest side portion of the frame region F, and hence the display quality can be maintained.

As for the narrow side Ea, Eb, and Ed portions of the frame region F, the whole of which are close to the display region D, the cell thickness is held with the sealing material 25a (granular or fibrous spacers contained in the sealing material 25a).

When a number of liquid crystal cells are arranged in a matrix to be adjacent to one another on a mother substrate, or when a bonding process is performed with dummy spacers placed around the liquid crystal cell, the spacing between the TFT substrate and the CF substrate can sometimes be held with the first column spacers 21a (and the dummy spacers placed around the liquid crystal cell) without the necessity of spacers contained in the sealing material 25a as described above. In this way, as long as the load at the bonding between the TFT substrate and the CF substrate can be supported by a sufficient number of first column spacers 21a placed on the mother substrate (and dummy spacers placed around the liquid crystal cell), the sealing material can be cured in this state and then hold the spacing between the TFT substrate and the CF substrate. Therefore, it is not necessarily required to have spacers in the sealing material 25a.

The sealing material 25a, formed into a frame as shown in FIGS. 1 and 2, has a widened seal joint S in the side Ec portion of the frame region F. The seal joint S is the portion where the start point Ps and the end point Pe of the drawing of the frame-shaped sealing material 25a joint with each other in the seal drawing process described later. While the width of the straight portion of the sealing material 25a is 0.8 mm, the width of the seal joint S is 1.4 mm to 1.6 mm. The sealing material 25a is unrecognizable when viewed from above the display plane (CF substrate 30a) since it is covered with the black matrix formed in the frame region.

The liquid crystal layer 40 includes nematic liquid crystal molecules 40a having electrooptical characteristics.

The liquid crystal cell 50a having the configuration described above operates as follows. In each pixel as the minimum unit of an image, once a source signal is sent to the TFT from the source driver circuit 15 at the time when the TFT is ON having a gate signal sent from the gate driver circuit 14, predetermined charge is written in the pixel electrode 11. This generates a potential difference between the pixel electrode 11 and the common electrode of the CF substrate 30a, causing a predetermined voltage to be applied across the liquid crystal layer 40. Using the aligned state of the liquid crystal molecules 40a that varies with the magnitude of the voltage applied across the liquid crystal layer 40, the permeability of light incident on the liquid crystal layer 40 from a backlight is adjusted, thereby to display an image.

Next, a method for manufacturing the liquid crystal cell 50a will be described. The manufacturing method in this embodiment includes a TFT substrate producing process, a CF substrate producing process, a seal drawing process, a liquid crystal drop process, a bonding process, and a cutting process.

<TFT Substrate Producing Process>

The gate lines, the source lines, the TFTs, the pixel electrodes 11, and the like are formed on the glass substrate 10a having a thickness of 0.5 mm, for example, by a known method, to produce the TFT substrate 20a. During this production, as described earlier, the gate driver circuit 14, the source driver circuit 15, the peripheral circuit 16, the lead interconnects 12, and the connecting terminals 13 are formed monolithically. On the TFT substrate 20a, a polyimide resin film is formed covering the pixel electrodes 11 and then rubbed, to form an alignment film.

<CF Substrate Producing Process>

The black matrix, the color filter layer, the common electrode, the first column spacers 21a, the second column spacers 22a, and the like are formed on the glass substrate 10b having a thickness of 0.5 mm, for example, by a known method, to produce the CF substrate (30a). At this time, a wastable substrate portion facing the terminal region of the TFT substrate 20a remains undetached from the CF substrate (30a). On the CF substrate (30a), a polyimide resin film is formed covering the common electrode, the first column spacers 21a, and the second column spacers 22a and then rubbed, to form, an alignment film.

The first column spacers 21a and the second column spacers 22a are formed by patterning a photosensitive resin into a predetermined shape. Instead of making smaller the diameter of the second column spacers 22a than that of the first column spacers 21a, the height of the second column spacers (22a) may be made smaller than that of the first column spacers 21a, or the arrangement density of the second column spacers (22a) may be made lower than that of the first column spacers 21a. To make the second column spacers (22a) shorter than the first column spacers 21a, only the black matrix may be formed as the underlying film of the second column spacers while the multilayer film of the black matrix and the coloring layer is formed as the underlying film of the first column spacers 21a, for example.

<Seal Drawing Process>

For example, the sealing material 25a is formed into a frame in the four side portions of the frame region F on the CF substrate (30a) produced in the CF substrate producing process using a dispenser. The sealing material 25a may be a UV-cured resin, a UV-cured and thermosetting resin, and the like. The sealing material 25a is formed to be apart from both the edge of the substrate and the display region D by about several hundreds of μm. In other words, the sealing material 25a is kept from coining into contact with both the edge of the substrate and the display region D. As another method for forming the frame-shaped sealing material 25a, screen printing may be adopted. This method however has problems such as distortion and breakage of a screen and contamination of the substrate by contact with the screen. Hence, in an active matrix liquid crystal cell in which the frame region F is narrow and impurity management of the liquid crystal material is required, the drawing method using a dispenser, which involves no contact with the substrate and is high in drawing position precision, is preferred.

A feature of the present invention is that at the drawing of the frame-shaped sealing material 25a, as shown in FIG. 2, Lca>Laa=Lba=Lda is satisfied where Laa, Lba, Lca, and Lda are respectively the distances between the edge of the CF substrate 30a and the center of the drawing of the frame-shaped sealing material 25a on the sides Ea, Eb, Ec, and Ed. Also, the seal joint S is located at an arbitrary position on the portion of the sealing material 25a on the side Ec. In other words, the seal joint S is formed in the side Ee portion of the frame region F close to the terminal region T, and only the side portion of the sealing material 25a having the seal joint S is displaced toward the display region D to be apart from the cutting line, compared with the other three side portions of the sealing material 25a. When the TFT substrate 20a and the CF substrate 30a are bonded together, the sealing material 25a spreads roughly symmetrically with respect to the center of the drawing. Therefore, the eater of the drawing may be considered to become the center of the finished frame of the sealing material 25a in the width direction.

The side Ec portion of the frame region F close to the terminal region T is widest due to the reason described above. Hence, the center of the drawing of the portion of the sealing material 25a on the side Ec can be displaced toward the display region D compared with the other portions of the sealing material 25a on the sides Ea, Eb, and Ed. The amount of displacement (offset) of the drawing position of the side Ec portion of the sealing material 25a may be set considering the width of the seal joint S. In the meantime, consideration must be made to avoid a problem that may occur if the side Ec portion of the sealing material 25a is excessively close to the display region D. Accordingly, it is preferred to set the center of the drawing of the side Ec portion of the sealing material 25a at least somewhere in the outer part of the side Ec portion of the frame region F with respect to the center thereof in the width direction. In other words, Lca<Lea/2 is preferred where Lea is the width of the side Ec portion of the frame region F.

To state specifically, by using the seal setting of (the finished line width of the sealing material 25a)=0.8 mm, Lca=0.9 mm, and Laa=Lba=Lda=0.73 mm, the width of at least one of the side Ea, Eb, and Ed portions of the frame region F can be 1.8 mm, and the width of the side Ec portion of the frame region F can be about 2 mm to 5 mm depending on the configuration and size of the monolithic circuits.

Preferably, only the side portion of the sealing material 25a in the widest side portion of the frame region F is displaced. In the one drop fill method, the total drop amount of the liquid crystal material is adjusted by (the amount of one drop of the liquid crystal material)×(the number of drops). In liquid crystal cells for cellular phones, which are small in diagonal screen size and small in cell capacity, variations in the drop amount of the liquid crystal material, i.e., unevenness in cell thickness caused by an excessive or short liquid crystal material is apt to become apparent. In liquid crystal cells having a comparatively large screen, also, the cell capacity is small when the cell thickness is small. For example, the cell thickness is small in the following types of liquid crystal cells: a single-polarizer reflective liquid crystal cell whose reflection layer is inside the cell; a two-polarizer transflective liquid crystal cell with a multi-gap layer placed inside the cell; and two-polarizer transmissive and transflective liquid crystal cells using vertically aligned liquid crystal (with a multi-gap layer for the transflective type). Incidentally, in conventional two-polarizer transmissive liquid crystal cells using TN liquid crystal, in which the cell thickness is comparatively large, control of the drop amount is considered not so much difficult. In liquid crystal cells for cellular phones, also, visibility must be secured irrespective of the surrounding environment. As liquid crystal cells for cellular phones, therefore, transflective liquid crystal cells capable of using ambient light and vertically-aligned, normally-black liquid crystal cells capable of obtaining very high contrast are preferred, and for this reason, the capacity of liquid crystal cells suitable for cellular phones tends to be small. Also, the cell thickness is sometimes made smaller for improving the response speed of the liquid crystal layer. In consideration of the above, in liquid crystal cells for cellular phones, the side Ea, Eb, and Ed portions of the sealing material 25a are preferably formed to be closer to the edge of the CF substrate 30a, to ensure that the cell capacity is prevented from being unnecessarily small.

In this embodiment, the sealing material 25a overlaps the lead interconnects 12 running from the monolithic circuits of the TFT substrate 20a. This will cause no problem as long as a resin that can be sufficiently light-cured with an aperture of L/S (line and space) of about 40 μm/10 μm, for example, is used.

<Liquid Crystal Drop Process>

In the CF substrate (30a) having the sealing material 25a formed in the seal drawing process described above, the liquid crystal material is dropped in the region surrounded by the sealing material 25a. The sealing material 25a may be formed on the TFT substrate 20a and then the liquid crystal material may be dropped inside the frame of the sealing material 25a. In this case, however, drop traces tend to occur, and the circuits and the like on the TFT substrate 20a may be subjected to static damage. It is therefore preferred to form the sealing material 25a and drop the liquid crystal material on the CF substrate 30a.

<Bonding Process>

The CF substrate (30a) with the liquid crystal material dropped in the liquid crystal drop process described above and the TFT substrate 20a produced in the TFT substrate producing process described above are bonded together under a reduced pressure so that the display regions D of these substrates coincided with each other. The bonded body is then exposed to the atmosphere, to apply pressure to the surface of the bonded body.

The frame region F of the bonded body is irradiated with UV light for pre-curing of the sealing material 25a, and then heated for post-curing of the sealing material 25a.

<Cutting Process>

A cutting blade is rolled on the outer surface of the CF substrate (30a) of the bonded body, in which the sealing material 25a has been cured in the bonding process described above, with its edge being kept abutting against the surface, thereby to form a crack. The crack is allowed to proceed in the substrate thickness direction, thereby to remove the wastable substrate portion of the CF substrate (30a). In this embodiment, good cutting on the side Ec is secured when the thicknesses of the TFT substrate 20a/CF substrate 30a are 0.5 mm/0.5 mm. The cutting on the side Ec is also found good when they are 0.4 mm/0.4 mm, 0.3 mm/0.2 mm, 0.3 mm/0.1 mm, 0.4 mm/0.3 mm, and 0.25 mm/0.15 mm.

The liquid crystal cell 50a can be manufactured in the manner described above.

As described above, in the liquid crystal cell 50a of this embodiment, the portion of the sealing material 25a in the widest side Ec portion of the frame region F, among the four side portions thereof, has the widened seal joint S and is farther from the edge of the CF substrate 30a than the portions of the sealing material 25a in the other three side Ea, Eb, and Ed portions of the frame region F, allowing the seal joint S to be apart from the edge of the CF substrate 30a. Hence, since the seal joint S is apart from the edge of the CF substrate 30a, i.e., the cutting line of the CF substrate 30a at the cutting from the mother substrate, good cutting can be done on the side Ec of the CF substrate 30a where the seal joint S is formed. Thus, cutting failure caused by the seal joint S can be suppressed.

In the liquid crystal cell 50a of this embodiment, also, the spacing between the TFT substrate 20a and the CF substrate 30a, i.e., the cell thickness is held with the first column spacers 21a in the display region D. The cell thickness is held with the second column spacers 22a in the relatively wide side Ec portion of the frame region F, and is held with the sealing material 25a in the relatively narrow side Ea, Eb, and Ed portions of the frame region F. The second column spacers 22a are lower in arrangement density or smaller than the first column spacers 21a. Therefore, the portion of the sealing material 25a in the wide portion of the frame region F can be drawn precisely without being impeded by the second column spacers 22a. Also, with the second column spacers 22a formed in the wide side Ec portion of the frame region F, the cell thickness is kept from changing abruptly at and around the boundary between the display region D and the wide side Ec portion of the frame region F, and hence the display quality can be maintained. In the narrow side Ea, Eb, and Ed portions of the frame region F, which are less influential to the display quality, the cell thickness is held, not with column spacers, but with only the sealing material. In this way, in the liquid crystal cell 50a, the frame can be narrowed while the display quality is maintained.

In the liquid crystal cell 50a of this embodiment, the seal joint S is apart from the edge of the CF substrate 30a, i.e., the cutting line of the CF substrate 30a at the cutting from the mother substrate. Therefore, even though the seal joint S overlaps a monolithic circuit or the lead interconnects 12 running from the monolithic circuit, or the CF substrate 30a is relatively thin, good cutting can be done on the side Ec of the CF substrate 30a on which the seal joint S is formed. Moreover, since the substrate can be thinned in addition to the narrowed frame region F, a thin, light-weight liquid crystal cell can be implemented.

In the liquid crystal cell 50a of this embodiment, the terminal region T and the wide side portion of the frame region F are adjacent to each other. Therefore, the degree of freedom in the layout of the lead interconnects 12 running from the wide side portion of the frame region F to the terminal region T can be improved.

In the liquid crystal cell 50a of this embodiment, the positions of interconnects can be set without considering the position of the seal joint S. This permits design of a liquid crystal cell having a high degree of freedom in wiring and terminal positions. As a result, with a variety of mounting forms being available, the design property of electronic equipment having a liquid crystal cell can be improved. In particular, in liquid crystal cells of the three-side free structure, the layout of the side portion close to the terminal region T governs the degree of freedom in mounting. Hence, the feature that the degree of freedom in wiring is not degraded in the side portion close to the terminal region T, where the seal joint S is formed, is advantageous in improving the design of electronic equipment. Also, with the increased degree of freedom in mounting, room can be left for adjusting the design of the terminal region T of the liquid crystal cell to curb increase in the number of components and cost. Hence, this embodiment is also advantages from the standpoint of cost design.

### Embodiment 2

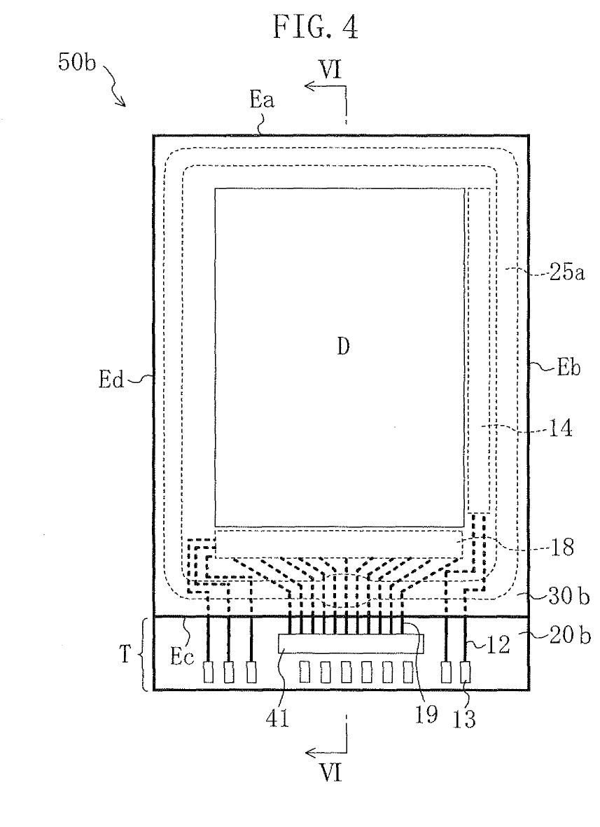

FIGS. 4 to 6 show a display cell (liquid crystal cell) of Embodiment 2 of the present invention. Note that the same components as those in FIGS. 1 to 3 are denoted by the same reference numerals, and detailed description thereof is omitted.

In Embodiment 1 described above, the gate driver circuit 14 and the source driver circuit 15 are formed monolithically. However, the present invention is not limited to this configuration.

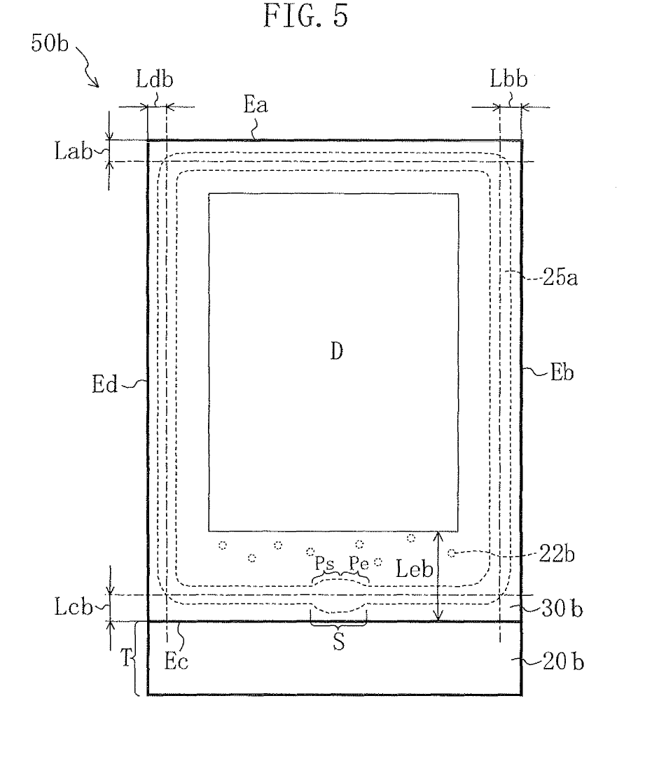

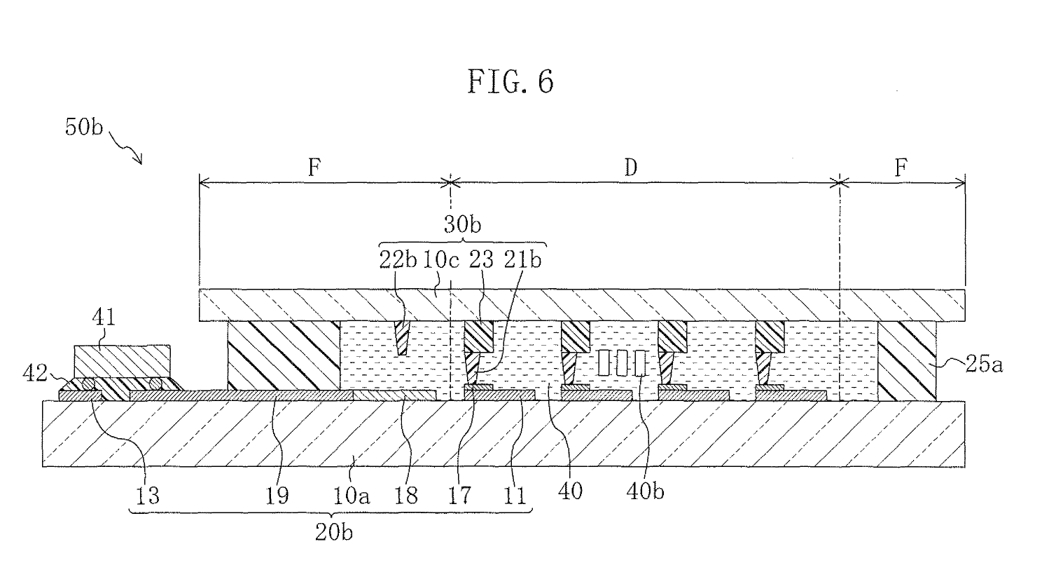

Specifically, FIG. 4 is a plan view of a liquid crystal cell 50b of this embodiment, FIG. 5 is a plan view illustrating a configuration of the sealing material 25a in the liquid crystal cell 50b, and FIG. 6 is a cross-sectional view of the liquid crystal cell 50b taken along line VI-VI in FIG. 4.

As shown in FIGS. 4 to 6, the liquid crystal cell 50b includes: a TFT substrate 20b as the first substrate; a CF substrate 30b as the second substrate opposed to the TFT substrate 20b; the liquid crystal layer 40 formed between the TFT substrate 20b and the CF substrate 30b; the frame-shaped sealing material 25a for attaching the TFT substrate 20b and the CF substrate 30b to each other and sealing the liquid crystal layer 40 between the TFT substrate 20b and the CF substrate 30b; and an integrated circuit (IC) chip 41 mounted in the terminal region T on the TFT substrate 20b.

In the liquid crystal cell 50b, as shown in FIG. 6, the TFT substrate 20b includes: reflection electrodes 17 placed to overlap the portion of the pixel electrodes 11; and a RGB switch circuit 18 and lead interconnects 19 running therefrom formed in the wide side Ec portion of the frame region F. The CF substrate 30b includes a multi-gap layer 23 formed to correspond to the reflection electrodes 17 of the TFT substrate 20b. The liquid crystal cell 50b is adapted to transflective display, where reflection display is performed in narrow-cell regions having the reflection electrodes 17 and the multi-gap layer 23 and transmission display is performed in wide-cell regions having neither the reflection electrodes 17 nor the multi-gap layer 23.

Specifically, as shown in FIG. 4, the TFT substrate 20b has the ROB switch circuit 18 as a monolithic circuit and the lead interconnects 19 in the wide side Ec portion of the frame region F as described above, and also has the gate driver circuit 14 as a monolithic circuit in the narrow side Eb portion of the frame region F.

The RGB switch circuit 18 is a circuit that, in time-sharing of one lead interconnect among a plurality of (e.g., three R, G, and B) source lines, sorts a video signal inputted from outside via the lead interconnect 19 to the sharer source lines sequentially at predetermined timing.

The IC chip 41, having bump electrodes on the bottom, is connected with the connecting terminals 13 formed in the terminal region T of the TFT substrate 20b via an anisotropic conductive film (ACF) 42, for example.

As shown in FIG. 6, the CF substrate 30b includes first column spacers 21b formed on the multi-gap layer 23 in the display region D and second column spacers 22b formed on a glass substrate 10c in the side Ec portion of the frame region F.

The first column spacers 21b are post spacers of a roughly cylindrical shape having a height of several μm, for example, formed on the multi-gap layer 23 to hold the spacing between the TFT substrate 20b and the CF substrate 30b, i.e., the cell thickness in the display region D. The first column spacers 21b are placed at a density of one for each pixel or one for each coloring layer of a specific color, or at random, in the display region D.

The second column spacers 22b are post dummy spacers of a roughly cylindrical shape having a height of several μm, for example, configured to hold the spacing between the TFT substrate 20b and the CF substrate 30b, i.e., the cell thickness in the wide side Ec portion of the frame region F. The first column spacers 21b, which are formed on the multi-gap layer 23, protrude farther than the second column spacers 22b, and resultantly the second column spacers 22b are shorter than the first column spacers 21b. Therefore, the second column spacers 22b are less likely to interfere with sensing of the dispenser in drawing of the portion of the sealing material 25a in the seal drawing process.

The liquid crystal layer 40 includes vertically aligned liquid crystal molecules 40b whose dielectric anisotropy is negative (Δε<0).

In the liquid crystal cell 50b, as shown in FIG. 4, the source driver circuit is constructed of the external IC chip 41 mounted in the terminal region T and the RGB switch circuit 18 formed monolithically on the TFT substrate 20b inside the cell. This configuration permits use of a high-performance IC manufactured from a Si wafer and hence implementation of a low-power liquid crystal cell. By combining this configuration with the reflection display mode that uses ambient light without use of a backlight, power consumption can be further reduced. Therefore, this combination is often adopted in recent transflective liquid crystal cells.

The IC chip 41 and the RGB switch circuit 18 are connected with each other via fan-shaped group of interconnects (lead interconnects 19) formed on the TFT substrate 20b. For this reason, the side Ec portion of the frame region F close to the terminal region T, in which the fan-shaped group of interconnects run, tends to be wide compared with the other side Ea, Eb, and Ed portions of the frame region F.

Next, the method for manufacturing the liquid crystal cell 50b having the configuration described above will be described.

The TFT substrate 20b is produced in the following manner. After formation of the pixel electrodes 11 in the TFT substrate producing process described in Embodiment 1, the reflection electrodes 17 are formed on the pixel electrodes 11. Also, the RGB switch circuit 18 is formed monolithically.

The CF substrate 30b is produced in the following manner. Before formation of the common electrode in the CF substrate producing process described in Embodiment 1, the multi-gap layer 23 is formed with a photosensitive resin. After formation of the common electrode, the first and second column spacers 21b and 22b are formed. To set the height of the second column spacers 22b, the number of underlying films for the second column spacers 22b in the frame region F may be made smaller than that for the first column spacers 21b in the display region D.

The glass substrate 10c of the CF substrate 30b has a thickness of 0.2 mm, for example, which is smaller than the thickness (0.5 mm) of the glass substrate 10a of the TFT substrate 20b.

The way of drawing the frame-shaped sealing material 25a is substantially the same as the seal drawing process in Embodiment 1. That is, as shown in FIG. 5, at the drawing of the frame-shaped sealing material 25a, Lcb>Lab=Lbb=Ldb should be satisfied where Lab, Lbb, Lcb, and Ldb are respectively the distances between the edge of the CF substrate 30b and the center of the drawing of the frame-shaped sealing material 25a on the sides Ea, Eb, Ec, and Ed. The displacement of the drawing position of the side Ec portion of the sealing material 25a is preferably as follows. The center of the drawing of the side Ec portion of the sealing material 25a is preferably set at least somewhere in the outer part of the side Ec portion of the frame region F with respect to the center thereof in the width direction, considering the widened width of the seal joint S and also for the purpose of avoiding a problem that may occur if the side Ec portion of the sealing material 25a is excessively close to the display region D. In other words, Lcb<Leb/2 is preferred where Leb is the width of the side Ee portion of the frame region F.

The liquid crystal drop process for dropping the liquid crystal material on the CF substrate 30b, the process of bonding the TFT substrate 20b and the CF substrate 30b together, and the process of cutting the bonded body are substantially the same as those in Embodiment 1.

As described above, in the liquid crystal cell 50b of this embodiment, the portion of the sealing material 25a in the widest side Ec portion of the frame region F, among the four side portions thereof, has the wide seal joint S and is farther from the edge of the CF substrate 30b than the portions of the sealing material 25a in the other three side Ea, Eb, and Ed portions of the frame region F, allowing the seal joint S to be apart from the edge of the CF substrate 30b. Hence, since the seal joint S is apart from the edge of the CF substrate 30b, i.e., the cutting line of the CF substrate 30b at the cutting from the mother substrate, good cutting can be done on the side Ec of the CF substrate 30b where the seal joint S is formed. Thus, cutting failure caused by the seal joint S can be suppressed.

In the liquid crystal cell 50b of this embodiment, the fan-shaped group of lead interconnects 19 are placed in the wide side Ec portion of the frame region F, and the sealing material 25a is apart from the cutting line of the CF substrate 30b. Hence, even if the sealing material 25a spreads, it will not reach the cutting line, avoiding the possibility of impeding the cutting. As the fan-shaped group of interconnects, whose wiring resistance is desirably low, metal interconnects are preferably used. However, a thick wiring material that raises the height of the underlying layer of the sealing material 25a may cause spreading of the sealing material 25a. It is known that having the RGB switch circuit 18, the number of interconnects for connecting the RGB switch circuit 18 with the IC chip 41 can be reduced from the number of source lines in the display region D. Even with this reduction, several hundreds of interconnects are still grouped into the fan shape. Having these interconnects, the ups and downs of the surface of the underlying layer at the drawing position of the sealing material 25a tend to raise the height in average, and hence the finished line width of the sealing material 25a tends to be unstable. According to the liquid crystal cell 50b of this embodiment, even if the finished line width of the sealing material 25a is unstable, the possibility of the sealing material 25a impeding the cutting can be avoided for the reason described above.

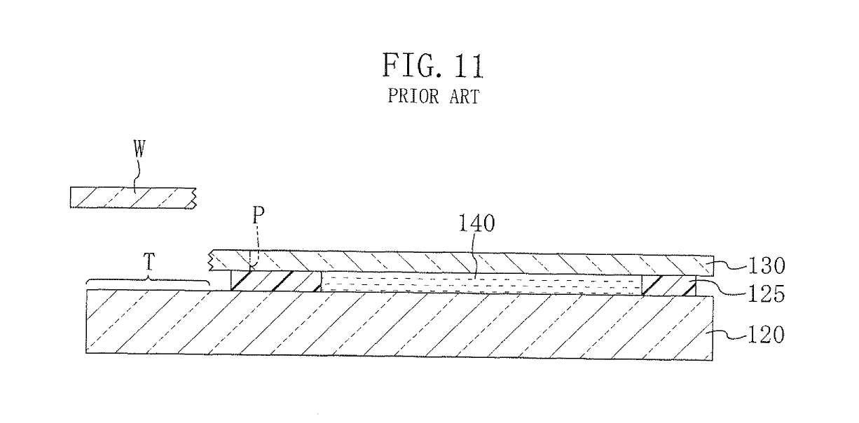

In the liquid crystal cell 50b of this embodiment, in which the IC chip 41 is mounted on the terminal region T of the relatively thick TFT substrate 20b, the TFT substrate 20b is prevented from cracking and chipping during the mounting of the IC chip 41. To mount the external IC chip 41 on the terminal region T as an end portion of the TFT substrate 20b, the terminal region must be widened to secure the mounting space. From the standpoint of prevention of cracking and chipping, therefore, the TFT substrate 20b cannot be thinned excessively. Hence, to reduce the total thickness of the liquid crystal cell 50b (total of the thicknesses of the TFT substrate 20b and the CF substrate 30b), the CF substrate 30b is preferably thinned. In this case, if the sealing material 25a spreads over the cutting line, problems such as the following may occur: the CF substrate 30b, which is thin, may be broken during cutting of the liquid crystal cell from the mother substrate (see FIG. 11). In the liquid crystal cell 50b, the position of the sealing material 25a is away from the cutting line of the CF substrate 30b on the side Ec as described above. Therefore, even if the sealing material 25a spreads, it will not reach the cutting line. No difficulty will therefore be found in cutting the liquid crystal cell 50b from the mother substrate even though the CF substrate 30b is thin.

The position of the fan-shaped group of interconnects can be set without considering the position of the seal joint S. This permits design of a liquid crystal cell having a high degree of freedom in wiring and terminal positions. As a result, with a variety of mounting forms being available, the design property of electronic equipment having a liquid crystal cell can be improved. In particular, in the liquid crystal cell 50b of the three-side free structure, in which drive circuit components such as the IC chip 41 and FPC are placed on only the side Ec, the layout of the side portion close to the terminal region T governs the degree of freedom in mounting. Hence, the feature that the degree of freedom is not degraded in the wiring in the side portion close to the terminal region T, where the seal joint S is formed, is advantageous in improving the design of electronic equipment. When the external IC chip 41 is to be mounted on the terminal region T, it is sometimes necessary to procure a new driver IC spending high development cost because any existing driver IC chip cannot be converted to this use due to the design of the lead interconnects 12 of the connecting terminals 13, for example. This is due to the following reasons. In liquid crystal cells of the three-side free structure, circuits and interconnects concentrate on one side. In this type of liquid crystal cells, therefore, the degree of freedom is low in circuits and interconnects. If the layout of circuits and interconnects and the seal joint are mutually exclusive, design of terminals must be made with careful consideration to avoid interference with each other. In the worst case, any existing circuit components cannot be converted to this use. According to the liquid crystal cell 50b of this embodiment, however, although the seal joint S is formed in the side portion of the frame region F along the terminal region T, the degree of freedom in mounting is not degraded. Hence, this embodiment has an advantage of permitting design involving conversion of existing parts to this use and reduction in the number of components and the cost of the components.

### Embodiment 3

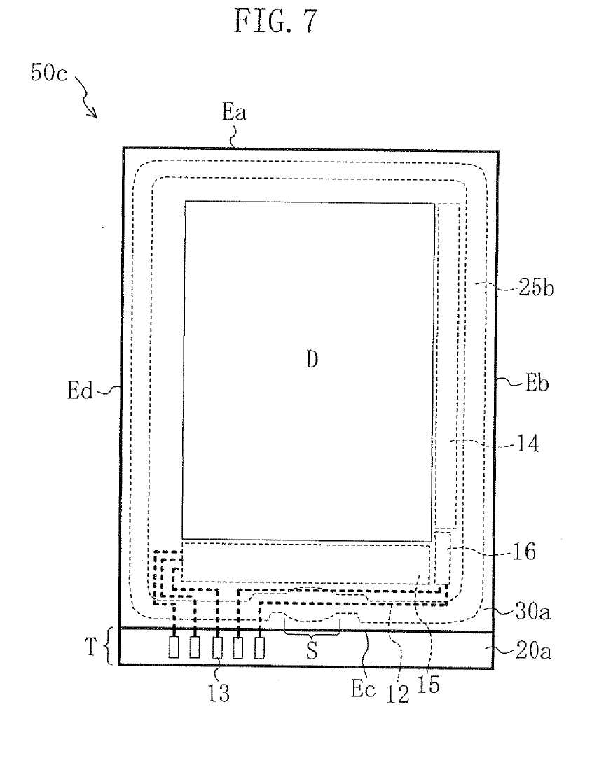

FIG. 7 shows a display cell (liquid crystal cell) of Embodiment 3 of the present invention. Specifically, FIG. 7 is a plan view of a liquid crystal cell 50c of this embodiment.

In the embodiments described above, the side portion of the sealing material 25a having the seal joint S is apart from the edge of the CF substrate uniformly from one end of the portion to the other end thereof. In this embodiment, only part of the side portion of a sealing material 25b having the seal joint S is curved to be closer to the display region D, and the seal joint S is formed in this curved part.

In the liquid crystal cell 50c of this embodiment, as in the above embodiments, the seal joint S of the sealing material 25b is apart from the edge of the CF substrate 30a. Hence, cutting failure caused by the seal joint S can be suppressed.

In the above embodiments, the liquid crystal cell is used as an example of the display cell. The present invention is not limited to the above embodiments, but any alteration can be made as long as it does not depart from the spirit of the invention. For example, the present invention can also be applied to display cells, such as an organic EL display device, which are not filled with a liquid crystal material but need sealing. The present invention is also applicable to devices, such as a resistive touch panel, in which a pair of substrates are bonded together forming sealing in a simple closed pattern.

In the embodiments described above, the color filter layer is formed on the CF substrate. According to the present invention, the color filter layer may be formed on the TFT substrate. The present invention is also applicable to an in-plane switching liquid crystal cell. In this case, the common electrode of the CF substrate is unnecessary.

In the embodiments described above, the active matrix liquid crystal cell using TFTs is used as the display cell. The present invention is also applicable to an active matrix liquid crystal cell using thin film diodes, a passive matrix liquid crystal cell, and a segment display liquid crystal cell.

In the embodiments described above, the seal joint S overlaps the lead interconnects running from the monolithic circuit. The present invention also includes a configuration of the seal joint S overlapping the monolithic circuit itself and a configuration of the seal joint S overlapping both the lead interconnects and the monolithic circuit.

In the embodiments described above, the sealing material is placed to be apart from the edge of the substrate in the widest side portion of the frame region among the four side portions thereof, and the seal joint is formed in the widest side portion of the frame region. If the second widest side portion of the frame region has a width equal to or more than a predetermined width, the sealing material may be placed to be apart from the edge of the substrate in the second widest side portion of the frame region, and the seal joint may be formed in the second widest side portion of the frame region.

### INDUSTRIAL APPLICABILITY

As described above, according to the present invention, cutting failure of liquid crystal cells can be suppressed. The invention is therefore useful in display cells manufactured by bonding a pair of substrates together with a sealing material.

1. A display cell, comprising:
a first substrate;
a terminal region defined along one side of the first substrate;
a second substrate opposed to the first substrate so that the terminal region is exposed;
a frame-shaped sealing material configured to attach the first substrate and the second substrate to each other and have a widened seal joint;
a display region defined inside the frame of the sealing material; and
a frame region having four side portions defined around the display region, the sealing material being placed in the frame region,
wherein
the sealing material is placed to be farther from the edge of the second substrate in a widest side portion of the frame region, among the four side portions thereof, than in the other three side portions, and has the seal joint in the widest side portion.

2. The display cell of claim 1, wherein a plurality of first column spacers for holding the spacing between the first substrate and the second substrate are formed in the display region,
a plurality of second column spacers for holding the spacing between the first substrate and the second substrate are formed in the widest side portion of the frame region, the second column spacers being lower in arrangement density than the first column spacers, or smaller than the first column spacers, and
the spacing between the first substrate and the second substrate is held with the sealing material in the other three side portions of the frame region.

3. The display cell of claim 1, wherein a monolithic circuit is formed in the widest side portion of the frame region of the first substrate.

4. The display cell of claim 3, wherein the seal joint overlaps the monolithic circuit or a lead interconnect running from the monolithic circuit.

5. The display cell of claim 1, wherein the second substrate is thinner than the first substrate.

6. The display cell of claim 5, wherein an integrated circuit chip is mounted on the terminal region.

7. The display cell of claim 1, wherein the terminal region is adjacent to the widest side portion of the frame region.

8. The display cell of claim 1, wherein a liquid crystal layer sealed with the sealing material is formed between the first substrate and the second substrate.

9. The display cell of claim 1, wherein the sealing material is placed by drawing, and
the seal joint is a portion where the start point and the end point of the drawing join with each other.
